(19) United States
(12) Patent Application Publication
(10) Pub. No.: US 2024/0119643 A1
(43) Pub. Date: Apr. 11, 2024

(54) IMAGE PROCESSING DEVICE, IMAGE PROCESSING METHOD, AND COMPUTER-READABLE STORAGE MEDIUM

(71) Applicant: JVCKENWOOD Corporation, Yokohama-shi (JP)

(72) Inventors: Hisashi Oka, Yokohama-shi (JP); Tetsuji Suzuki, Yokohama-shi (JP); Takayuki Sugahara, Yokohama-shi (JP)

(21) Appl. No.: 18/393,809

(22) Filed: Dec. 22, 2023

Related U.S. Application Data
(63) Continuation of application No. PCT/JP2022/024980, filed on Jun. 22, 2022.

(30) Foreign Application Priority Data
Jun. 25, 2021 (JP) 2021-105936
Mar. 3, 2022 (JP) 2022-032920

(51) Int. Cl. G06T 11/00; G06V 20/20; G06V 40/16

(52) U.S. Cl. CPC G06T 11/00; G06V 20/20; G06V 40/161

(57) ABSTRACT

An image processing device includes: an object information acquisition unit configured to acquire information on a first object; an object detection unit configured to detect from image data the first object and a second object associated with the first object; and a display mode change unit configured to change a display mode of the second object when the first object is detected and the second object is not a predetermined human face, and not change the display mode of the second object when the first object is detected and the second object is a predetermined human face.

### CROSS-REFERENCE TO RELATED APPLICATION

This application is a Continuation of PCT International Application No. PCT/JP2022/024980 filed on Jun. 22, 2022 which claims the benefit of priority from Japanese Patent Application No. 2021-105936 filed on Jun. 25, 2021 and Japanese Patent Application No. 2022-032920 filed on Mar. 3, 2022, the entire contents of all of which are incorporated herein by reference.

### BACKGROUND

The present invention relates to an image processing device, an image processing method, and a computer-readable storage medium.

### DESCRIPTION OF THE RELATED ART

Conventionally, there has been a technology for assigning, to a piece of video data to be visually perceived by a user, information indicating the kind of scene the piece of video data represents, based on image data output in units of frames (for example, see Japanese Patent Application Laid-open No. 2018-42253).

When the image data is to be processed as disclosed in Japanese Patent Application Laid-open No. 2018-42253, there is a need for providing an image suitable for a demand of a user.

### SUMMARY OF THE INVENTION

An image processing device according to an aspect of the present disclosure includes: an object information acquisition unit configured to acquire information on a first object; an object detection unit configured to detect from image data the first object and a second object associated with the first object; and a display mode change unit configured to change a display mode of the second object when the first object is detected and the second object is not a predetermined human face, and not change the display mode of the second object when the first object is detected and the second object is a predetermined human face.

An image processing device according to another aspect of the present disclosure includes: an object information acquisition unit configured to acquire information on a specific location and information on a first object; a position information processing unit configured to determine whether a position of a user is within the specific location based on position information of the user; an object detection unit configured to detect from image data the first object associated with the specific location and a second object associated with the first object; and a display mode change unit configured to change a display mode of the second object when the position of the user is determined to be within the specific location and the first object associated with the specific location and the second object are detected.

An image processing method according to still another aspect of the present disclosure includes: acquiring information on a first object; detecting from image data the first object and a second object associated with the first object; and changing a display mode of the second object when the first object is detected and the second object is not a predetermined human face, and not changing the display mode of the second object when the first object is detected and the second object is a predetermined human face.

A non-transitory computer-readable storage medium according to even another aspect of the present disclosure stores a program causing a computer to execute: acquiring information on a first object; detecting from image data the first object and a second object associated with the first object; and changing a display mode of the second object when the first object is detected and the second object is not a predetermined human face, and not changing the display mode of the second object when the first object is detected and the second object is a predetermined human face.

### BRIEF DESCRIPTION OF THE DRAWINGS

FIG. 1 is a schematic illustrating an example of an image processing system according to the embodiment;

FIG. 2 is a schematic illustrating an example of an image displayed by an image processing device according to the embodiment;

FIG. 3 is a functional block diagram illustrating an example of the image processing system according to the embodiment;

FIG. 4 is a schematic illustrating an example of a main picture, and the main picture on which a sub-picture is superimposed, in the first embodiment;

FIG. 5 is a schematic illustrating an example of display mode change information according to the embodiment;

FIG. 6 is a flowchart according to the embodiment; and

FIG. 7 is a schematic illustrating an example of a main picture, and the main picture on which a sub-picture is superimposed, in a second embodiment.

### DETAILED DESCRIPTION

An image processing device, an image processing method, and a computer program according to an embodiment will now be explained with reference to drawings. The embodiment is, however, not intended to limit the scope of the present invention in any way. Furthermore, elements disclosed in the embodiment include those that can be replaceable by a person skilled in the art, or those that are substantially the same.

### First Embodiment

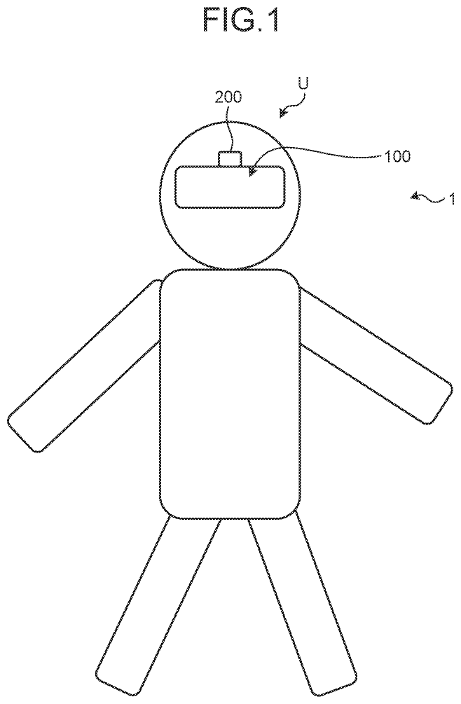

FIG. 1 is a schematic illustrating an example of an image processing system according to an embodiment. This image processing system 1 according to the first embodiment is a device that provides information to a user U by outputting visual stimuli to the user U. The image processing system 1 is what is called a wearable device that is mounted on the body of the user U, as illustrated in FIG. 1. In the example of the embodiment, the image processing system 1 includes an image processing device 100 worn over the eyes of the user U. The image processing device 100 worn over the eyes of the user U includes an output unit 120, to be described later, that outputs visual stimuli (displays an image) to the user U. The configuration illustrated in FIG. 1 is merely one example, and the number of devices may be any number, or the position where the user U wears the image processing device 100 may be any position. For example, the image processing system 1 may also be a device carried by the user U, e.g., what is called a smartphone or tablet terminal, without limitation to a wearable device.

Main Picture

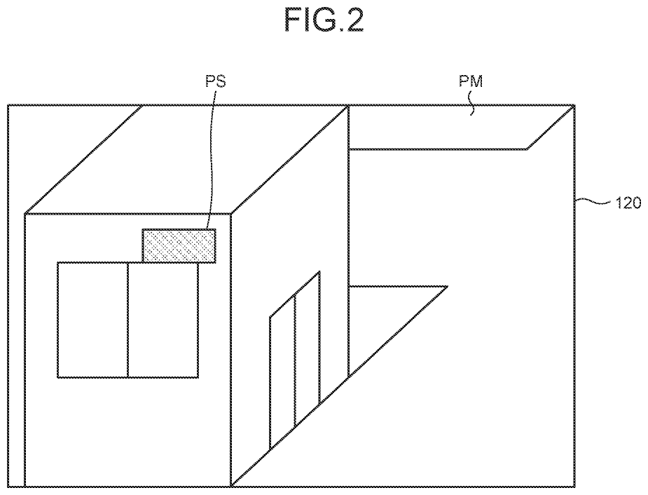

FIG. 2 is a schematic illustrating an example of an image displayed by the image processing device according to the embodiment. As illustrated in FIG. 2, the image processing system 1 presents a main picture PM to the user U through the output unit 120. With this, the user U wearing the image processing system 1 can visually perceive the main picture PM. In the embodiment, the main picture PM is an image of the scenery visually perceived by the user U, assuming that the user U is not wearing the image processing system 1, and can be said to be an image of actual objects that are present within the field of view of the user U. A field of view is the area where the user can perceive without moving his/her eyeballs, about the line of sight of the user U at the center.

In the embodiment, the image processing system 1 provides the main picture PM to the user U by allowing the output unit 120 to transmit the external light (the visible light in the surrounding environment), for example. In other words, in the embodiment, it can be said that the user U visually perceives the image of the actual scenery directly through the output unit 120. The image processing system 1 is, however, not limited to allowing the user U to visually perceive the image of the actual scenery directly, and may also provide the main picture PM to the user U through the output unit 120 by causing the output unit 120 to display the main picture PM thereon. In such a case, the user U visually perceives the image of the scenery displayed on the output unit 120 as the main picture PM. In such a case, the image processing system 1 causes the output unit 120 to display an image within the field of view of the user U captured by an image capturing unit 200 to be described later, as the main picture PM.

Sub-Picture

As illustrated in FIG. 2, the image processing system 1 causes the output unit 120 to display a sub-picture PS in a manner superimposed on the main picture PM provided through the output unit 120. As a result, the user U visually perceives an image of the main picture PM on which the sub-picture PS is superimposed. It can be said that a sub-picture PS is an image superimposed on the main picture PM and is an image other than the image of the actual scenery within the field of view of the user U. In other words, it can be said that the image processing system 1 provides the user U with an augmented reality (AR) by superimposing the sub-picture PS on the main picture PM representing the actual scenery.

In the manner described above, the image processing system 1 provides the main picture PM and the sub-picture PS, but may also cause the output unit 120 to present any images other than the main picture PM or the sub-picture PS.

Configuration of Image Processing System

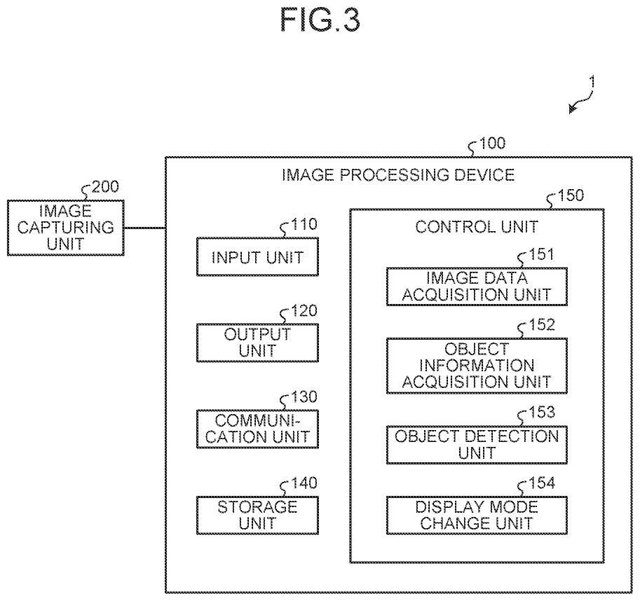

FIG. 3 is a functional block diagram illustrating an example of the image processing system according to the embodiment. As illustrated in FIG. 3, the image processing system 1 includes the image processing device 100 and the image capturing unit 200. The image processing device 100 includes an input unit 110, the output unit 120, a storage unit 140, a communication unit 130, and a control unit 150.

Image Capturing Unit

The image capturing unit 200 is an image capturing device, and captures an image around the image processing system 1 by detecting the visible light around the image processing system 1 as environment information. The image capturing unit 200 may be a video camera that captures images at a predetermined frame rate. The image capturing unit 200 may be provided to the image processing system 1 at any position or any orientation, the image capturing unit 200 illustrated in FIG. 1 is provided to the image processing device 100, as an example, and may capture an image in the direction in which the user U is facing. In this manner, the image capturing unit 200 can capture an image of the objects that are present in the direction of the line of sight of the user U, that is, the objects within the field of view of the user U. The number of the image capturing units 200 may be any number, and may be either one or more.

Input Unit

The input unit 110 is a device for receiving user operations, and may be a touch panel, for example.

Output Unit

The output unit 120 is a display that outputs the visual stimuli to the user U by displaying an image, and can be said to be a visual stimulation output unit. In the embodiment, the output unit 120 is what is called a head-mounted display (HMD). The output unit 120 displays the sub-picture PS in the manner described above. The output unit 120 may also include a sound output unit (speaker) outputting sound, or a tactile stimulation output unit outputting tactile stimuli to the user U. The tactile stimulation output unit outputs tactile stimuli to the user, by being physically actuated, such as vibrations. The type of the tactile stimuli, however, may be of any type, without limitation to the vibration.

Communication Unit

The communication unit 130 is a module that communicates with an external device or the like, and may include an antenna. In the embodiment, the communication unit 130 uses wireless communication as a communication scheme, but may use any type of communication scheme.

Control Unit

The control unit 150 is a processor that is a central processing unit (CPU). The control unit 150 includes an image data acquisition unit 151, an object information acquisition unit 152, an object detection unit 153, and a display mode change unit 154. The control unit 150 implements the image data acquisition unit 151, the object information acquisition unit 152, the object detection unit 153, and the display mode change unit 154, and executes processes thereof, by reading a computer program (software) from the storage unit 140 and executing the computer program. The control unit 150 may execute these processes using one CPU, or may include a plurality CPUs and executes the processes using such CPUs. At least some of the image data acquisition unit 151, the object information acquisition unit 152, the object detection unit 153, and the display mode change unit 154 may be implemented with the use of hardware.

Image Data Acquisition Unit

The image data acquisition unit 151 acquires image data via the image capturing unit 200. In the embodiment, the image data is an image of the main picture PM, and is the image of the environment visually perceived by the user U when it is assumed that the user U is not wearing the image processing system 1, and can be said to represent the image of the actual objects within the field of view of the user U. The image data acquisition unit 151 may also acquire the image data from the storage unit 140.

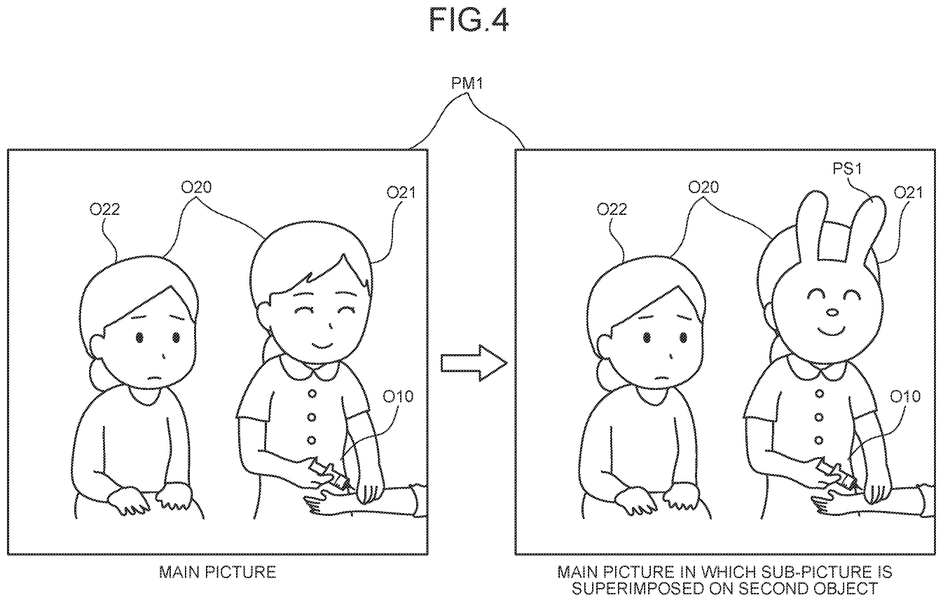

FIG. 4 is a schematic illustrating an example of a main picture, and the main picture on which a sub-picture is superimposed, in the first embodiment. In the example illustrated in FIG. 4, the image data acquisition unit 151 acquires a main picture PM1 being visually perceived by the user U as image data. In the example illustrated in FIG. 4, the main picture PM1 represents a scene in which a nurse is giving a shot to a child who is the user U, in the presence of his or her parent, and includes a syringe O10 and human faces O20. The scene of a nurse giving a shot will be used as an example in the explanation below, but the embodiment is not limited to this example.

Object Information Acquisition Unit

The object information acquisition unit 152 acquires first object information. The first object information is information on an object designated as a first object. The object information acquisition unit 152 can also be said to acquire information indicating the type of the first object (information indicating the type of the first object). In the embodiment, the object information acquisition unit 152 acquires information on an object that causes a fear or discomfort when the user U stares at the object, as the information on the first object.

An object herein is an actual object having a certain contour, and can be visually recognized. In the embodiment, the first object is an object that causes a fear or discomfort in the user U, as an example. The first object can also be said to be an object that could enhance the fear or discomfort in the user U when the user U stares at the object. In the example illustrated in FIG. 4, the syringe O10 corresponds to the first object.

Display Mode Change Information

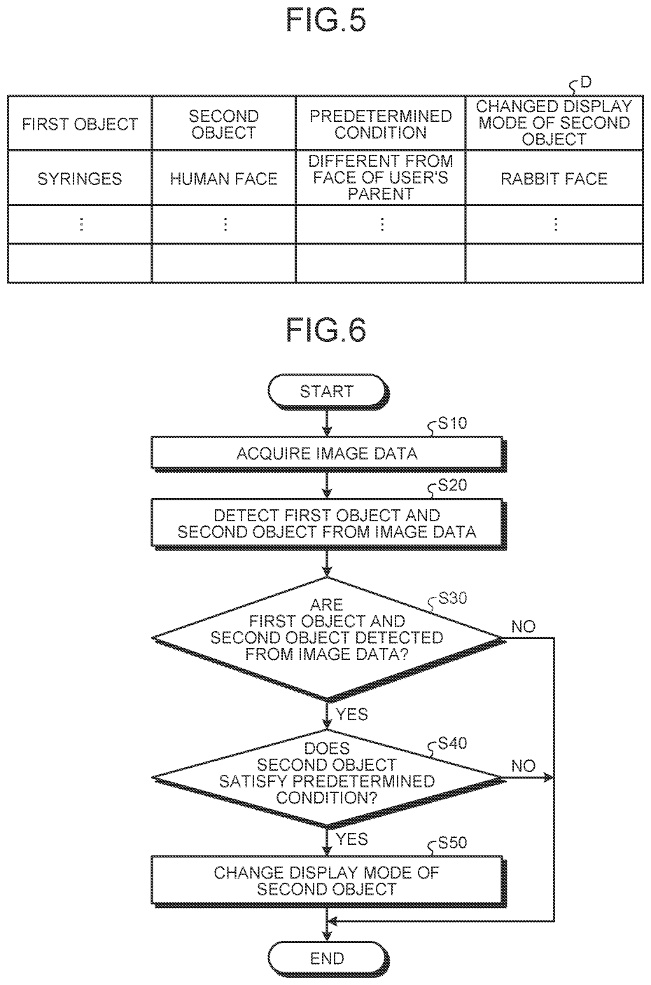

In the embodiment, the object information acquisition unit 152 acquires display mode change information D. FIG. 5 is a schematic illustrating an example of the display mode change information according to the embodiment. The display mode change information D is information including first object information, second object information, a predetermined condition, and a changed display mode of the second object. It can be said that the display mode change information D is data in which the first object, the second object, the predetermined condition, and the changed display mode of the second object are associated with one another. A second object is an object associated with the first object, and can also be said to be an object that is likely to be visually perceived with the first object by the user U. The predetermined condition is a condition related to the second object, under which the display mode of the second object is to be changed. In other words, the predetermined condition indicates a condition for selecting a second object for which the display mode is to be changed, among the second objects of a plurality of types. The changed display mode of the second object indicates a display mode for displaying the second object to be visually perceived by the user U, and more specifically, is information representing the sub-picture PS to be superimposed on the second object. The display mode change information D may include the second object information, the predetermined condition, and the changed display mode second object, correspondingly to each of the first objects that are different. In other words, it is possible to set a plurality of types of first objects, and to set the display mode change information D for each of such first objects.

The object information acquisition unit 152 may use any method to acquire the display mode change information D. For example, the first object, the second object, the predetermined condition, and the changed display mode of the second object may be entered by the user U. It is also possible for the object information acquisition unit 152 to use the first object information entered by the user U, to determine the second object, the predetermined condition, and the changed display mode of the second object. It is not mandatory for the user U to enter the settings for the display mode change information D, and the display mode change information D may be provided by default.

Object Detection Unit

The object detection unit 153 detects the first object and the second object associated thereto from the image data, based on the display mode change information D. More specifically, the object detection unit 153 detects whether the first object designated in the display mode change information D and the second object mapped with the first object in the display mode change information D are included in the image data (the main picture PM1 being visually perceived by the user). The object detection unit 153 may use any method to detect the first object and the second object, and may use an artificial-intelligence (AI) model to detect the first object and the second object, as an example. In such a case, the AI model is stored in the storage unit 140, and is a model for extracting objects included in an image from the image data, and for identifying their types. The AI model is a trained AI model built by carrying out a training using supervised data including a plurality of data sets. Each of the data sets contains a piece of image data and information indicating the type of the objects included in the image. In the example illustrated in FIG. 4, the syringe O10 is set as the first object, and the human face O20 is set as the second object. Therefore, the object detection unit 153 detects the syringe O10 that is the first object, and the human faces O20 that are the second objects associated with the syringe O10 in the display mode change information D, from the image data.

Display Mode Change Unit

When the first object is detected, the display mode change unit 154 changes the display mode of the second object. In the embodiment, when the first object and the second object are detected from the same image data, the display mode change unit 154 changes the display mode of the second object that satisfies the predetermined condition based on the display mode change information D. Specifically, the display mode change unit 154 determines whether the second object detected from the image data satisfies the predetermined condition specified in the display mode change information D.

When the second object is detected in plurality, the display mode change unit 154 determines whether each of the second objects satisfies the predetermined condition specified in the display mode change information D, and extracts the second object satisfying the predetermined condition. The display mode change unit 154 then changes the display mode of the second object by displaying the sub-picture PS at a position overlapping with the second object satisfying the predetermined condition. More specifically, the display mode change unit 154 displays the sub-picture PS, which is indicated in the display mode change information D, at a position overlapping with the second object satisfying the predetermined condition. For the second object not satisfying the predetermined condition, the display mode change unit 154 does not display the sub-picture PS at the position overlapping with the second object, so that the display mode of the second object remain unchanged.

In the embodiment, the sub-picture PS is an image displayed on the second object so to enable the gaze of the user to be directed less to the first object that is a specific object included in the main picture PM, and may be any image such as a character or an icon, or a combination thereof, as long as the image enables the gaze of the user U to be directed less to the first object. In the example illustrated in FIG. 4, because a condition of the second object for which the display mode is to be changed requires that the second object is different from the face O22 of the parent of the user U, when a syringe O10 and human faces O21 are detected, the display mode change unit 154 superimposes an image of a rabbit face, as an example of the sub-picture PS1, only on the nurse's face O21 satisfying the condition. By contrast, the display mode change unit 154 does not superimpose the sub-picture PS1 on the parent's face O22 not satisfying the predetermined condition. In such a case, the user U visually perceives the parent's face O22 as it is.

In the explanation above, a combination of the first object, the second object, the predetermined condition, and the changed display mode of the second object are set in advance as the display mode change information D, but the information is not limited thereto. For example, any image may be superimposed on the second object, without indicating the sub-picture PS that is the changed display mode of the second object. Furthermore, as the changed display mode of the second object, without limitation to the sub-picture PS to be superimposed on the second object, optical processing such as tone adjustment or blurring may be applied to the second object. In the explanation above, the second objects (the human faces O20 in the example explained herein) are detected and the display mode is changed only for the second object satisfying the predetermined condition (the nurse's face O21 in the example explained herein), but the embodiment is not limited thereto. For example, the predetermined condition may be applied upon detections of the second objects, and the object detection unit 153 may be configured to detect only the second object satisfying the predetermined condition. In other words, the object detection unit 153 may detect only the nurse's face O21, instead of detecting all of the human faces O20. Furthermore, the display mode change unit 154 may change the display mode of the second object when the first object is detected, without requiring the predetermined condition.

Storage Unit

The storage unit 140 is a memory for storing therein the results processed by the control unit 150 and various types of information such as computer programs, and includes at least one of a main memory such as a random access memory (RAM) and a read-only memory (ROM), and an external storage device such as a hard disk drive (HDD). The storage unit 140 stores therein the display mode change information D. The display mode change information D and the computer programs for the control unit 150, to be stored in the storage unit 140, may also be stored in a recording medium that is readable by the image processing system 1. The computer program for the control unit 150 and the display mode change information D stored in the storage unit 140 are not limited being stored in the storage unit 140 in advance, and may also be acquired by the image processing system 1 via the communication unit 130 from an external device, at the time of using these pieces of data.

Effects

There is a need for providing an image suitable for the demand of a user. In this regard, according to the embodiment, the attention of the user U can be directed to the second object, by setting the first object and changing the display mode of the second object associated thereto. By setting an object that is fearful or discomforting to the user U as the first object, for example, the gaze of the user U is directed less to the first object. In this manner, it is possible to provide an image suitable for the demand of a user.

Flowchart

FIG. 6 is a flowchart according to the embodiment. A process performed by the image processing device 100 will now be explained.

The image data acquisition unit 151 acquires image data via the image capturing unit 200 (Step S10). The object detection unit 153 then detects the first object and the second object associated with the first object from the image data, based on the display mode change information D (Step S20). If any first object is detected from the image data (Yes at Step S30) and the second object satisfies the predetermined condition (Yes at Step S40), the display mode change unit 154 changes the display mode of the second object (Step S50). If the second object does not satisfy the predetermined condition (No at Step S40), the display mode change unit 154 does not change the display mode of the second object. In this situation, the user U visually perceives an image of the second object that satisfies the predetermined condition, in the main picture PM, on which the sub-picture PS is superimposed, that is, the user U visually perceives the main picture PM in which the second object satisfying the predetermined condition is displayed in a different display mode. By contrast, if no first object is detected from the image data at Step S30 (No at Step S30), the display mode of the second object is kept unchanged. In this situation, the user U visually perceives only the main picture PM.

### Second Embodiment

A second embodiment is different from the first embodiment in that the display mode of the second object is changed so as to allow the user U to better recognize the first object. In the second embodiment, explanations of the parts having the same configurations as those of the first embodiment will be omitted.

Image Data Acquisition Unit

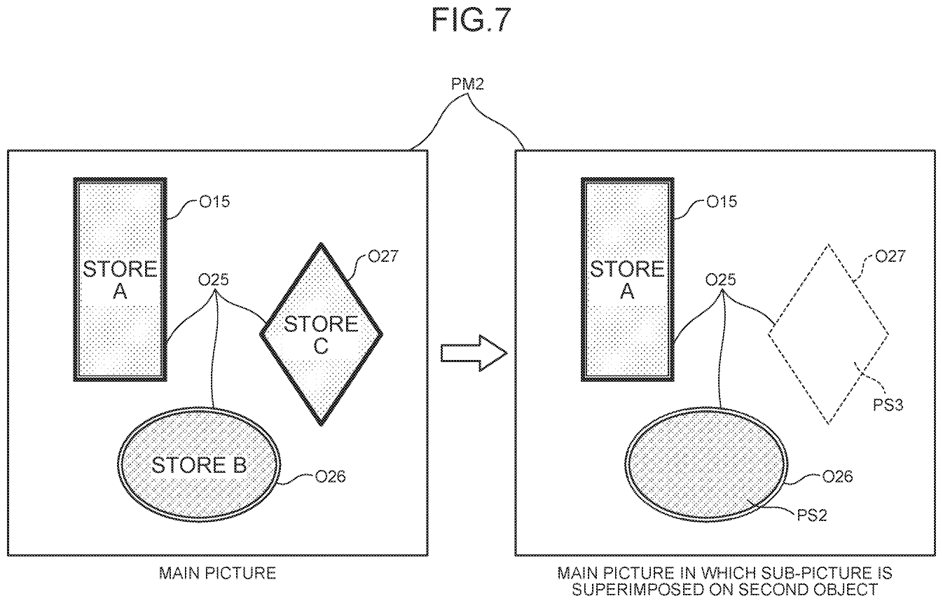

FIG. 7 is a schematic illustrating an example of a main picture, and the main picture on which a sub-picture is superimposed, in the second embodiment. In the example illustrated in FIG. 7, the image data acquisition unit 151 acquires a main picture PM2 being visually perceived by the user U as image data. In the example illustrated in FIG. 7, the main picture PM2 assumes a situation in which the user U is looking for a signboard of a store A in a downtown, and includes the signboard O15 of the store A, and signboards O25 of all of the stores. In the explanation below, a scene with the signboards of stores will be used as an example, but the embodiment is not limited to this example.

Object Information Acquisition Unit

In this embodiment, the object information acquisition unit 152 acquires the information on an object that the user U needs to recognize, as the first object information. In the embodiment, the first object is an object that the user U wants to recognize, for example, and therefore, the first object can also be said to be an object that the user U wants to find from the main picture PM2.

Object Detection Unit

In the example illustrated in FIG. 7, the object detection unit 153 detects the signboard O15 of the store A that is the first object, and the signboards O25 of all of the stores that are the second objects associated with the signboard O15 of the store A in the display mode change information D, from the image data.

Display Mode Change Unit

In the embodiment, the sub-picture PS is an image displayed over the second objects so as to make it easier to recognize the first object, which is a specific object included in the main picture PM, and may be any image such as a character or icon, or a combination thereof, as long as the image facilitates the user U to better recognize the first object. In the example illustrated in FIG. 7, because a condition of the second object for which the display mode is to be changed requires that the second object is different from the signboard O15 of the store A, when the signboard O15 of the store A and the signboards O25 of all of the stores are detected, the display mode change unit 154 performs processes such as superimposing the sub-picture PS2 so as to erase character information that is the characters on the signboard O26 of the store B satisfying the condition, or superimposing a sub-picture PS3 so as to erase the signboard O27 itself of the store C satisfying the condition, for example. By contrast, neither the sub-picture PS2 nor the sub-picture PS3 is superimposed on the signboard O15 of the store A not satisfying the predetermined condition, so that the user U visually perceives the signboard O15 of the store A as it is.

Effects

According to the embodiment, by setting the first object and changing the display mode of the second object associated thereto, the attention of the user U can be directed to the first object. With this, by setting an object that the user U wants to find out as the first object, for example, it is possible to make the first object more recognizable by the user U. In this manner, it is possible to provide an image suitable for the demand of a user.

### Third Embodiment

A third embodiment is different from the first embodiment in that the control unit 150 further includes a position information processing unit, and changes the display mode of the second object based on the information on a specific location. In the third embodiment, explanations of the parts having the same configurations as those of the first embodiment will be omitted.

Display Mode Change Information

In the embodiment, the display mode change information D is information further including information on a specific location. A specific location is a specific geographical area where the user can be, for example, and indicates a location where the user U is expected to use the image processing system 1. In the embodiment, the first object is an object characterizing the specific location, for example, and the first object can also be said to be an object that the user U is highly likely to visually perceive in the specific location. The display mode change information D may include the first object information, the second object information, and the changed display mode of the second object, for each of the specific locations that are different. In other words, the specific location may be set in plurality, and the display mode change information D may be set correspondingly to each of the specific locations.

Position Information Processing Unit

In the embodiment, the position information processing unit acquires user position information, and determines whether the user position is within the specific location, based on the display mode change information D. The user position information herein indicates the geographical position where the user U is actually located. The position information processing unit may use any method to acquire user position information, and, as an example, may acquire the user position information via the communication unit 130.

Object Detection Unit

In the embodiment, the object detection unit 153 detects the first object associated with a specific location and the second object associated with the first object from the image data, based on the display mode change information D. More specifically, the object detection unit 153 detects whether the first object associated with the specific location and the second object associated with the first object in the display mode change information D are included in the image data (in the main picture being visually perceived by the user), based on the display mode change information D.

Display Mode Change Unit

In the embodiment, when it is determined that the user position is within the specific location and that the first object and the second object are detected from the same image data, the display mode change unit 154 changes the display mode of the second object satisfying a predetermined condition, based on the display mode change information D.

In the explanation above, the first object is associated with the specific location, and the second object is associated with the first object in the display mode change information D, but the embodiment is not limited thereto. For example, it is possible for the first object not to be associated with a specific location, and for the second object to be associated with the specific location and the first object. In other words, when the user position is within the specific location, and the first object is detected from the image data, some image may be displayed in a manner superimposed on the second object that is associated with the specific location and the first object. In such a case, it can be said that the second object is an object associated with the first object and the specific location and is an object that is highly likely to be visually perceived with the first object by the user U in the specific location.

Furthermore, in the explanation above, a combination of the specific location, the first object, the second object, the predetermined condition, and the changed display mode of the second object is specified in advance as the display mode change information D, but the embodiment is not limited thereto. For example, without any setting of the first object, when the user position is within the specific location, some image may be superimposed on the second object associated with the specific location. In such a case, it can be said that the second object is an object associated with the specific location and is an object that is highly likely to be visually perceived by the user U in the specific location.

Effects

According to the embodiment, by specifying the specific location and by changing the display mode of the second object associated therewith, it is possible to change the display mode of the second object only when the user U is in the specific location. In this manner, it is possible to provide an image suitable for the demand of a user.

### Advantageous Effect Achieved by Embodiments

The image processing device, the image processing method, and the computer program described in each of the embodiment can be understood as follows, for example.

An image processing device according to a first aspect includes: the object information acquisition unit 152 that acquires information on a first object; the object detection unit 153 that detects from image data the first object and a second object associated with the first object; and the display mode change unit 154 that changes a display mode of the second object when the first object is detected. With this configuration, it is possible to detect a specific object from the image data, and to assign information for changing the display mode of the object to the image data, based on the demand of a user. In this manner, it is possible to provide an image suitable for the demand of a user.

In an image processing device according to a second aspect, the display mode of the second object is changed when the second object satisfies a predetermined condition, and the display mode of the second object is not changed when the second object does not satisfy the predetermined condition. With this, because the display mode of the second object can be changed selectively depending on the second object, it is possible to better respond to the demand of a user.

In an image processing device according to a third aspect, the object information acquisition unit 152 acquires display mode change information D that is a piece of data in which the first object, the second object, and the changed display mode of the second object are associated with one another; and the display mode change unit changes the display mode of the second object based on the display mode change information D when the first object is detected. With this, because the display modes of the second objects corresponding to a plurality of respective different first objects can be changed, it is possible to better respond to the demand of a user.

In an image processing device according to a fourth aspect, the display mode of the second object is changed so that the gaze of the user U visually perceiving the image is directed less to the first object. In this manner, when it is necessary to prevent the user from staring at the first object, by changing the display mode in such a manner that the second object stands out more, it becomes easier for the user to avoid staring at the first object. Therefore, it is possible to better respond to the demand of a user.

In an image processing device according to a fifth aspect, the display mode of the second object is changed so as to make it easier for the user U who is visually perceiving the image to recognize the first object. Specifically, in an image processing device according to the fifth aspect, the display mode of the second object is changed to a display mode in the character information is erased in the second object. As a result, when it is necessary for the user to recognize the first object, by changing the display mode in such a manner that the second object stands out less, it helps the user to recognize the first object. Therefore, it is possible to better respond to the demand of a user.

An image processing device according to a sixth aspect includes: the object information acquisition unit 152 that acquires information on a specific location, and information on a first object; the position information processing unit that determines whether a position of a user is within the specific location based on position information of the user; the object detection unit 153 that detects the first object associated with the specific location and a second object associated with the first object from image data; and the display mode change unit 154 that changes a display mode of the second object when the position of the user is determined to be within the specific location, and the first object associated with the specific location is detected. With this configuration, it is possible to detect a specific object that is present in a specific location from the image data, and to assign information for changing the display mode of the object to the image data, based on the demand of a user. In this manner, it is possible to provide an image suitable for the demand of a user.

An image processing device according to a seventh aspect includes: the object information acquisition unit 152 that acquires information on a specific location, and information on a first object; the position information processing unit that determines whether a position of a user is within the specific location based on position information of the user; the object detection unit 153 that detects the first object and a second object associated with the specific location and the first object from image data; and the display mode change unit 154 that changes a display mode of the second object when the position of the user is determined to be within the specific location and the first object is detected. With this configuration, it is possible to detect a specific object that is present in a specific location from the image data, and to assign information for changing the display mode of the object to the image data, based on the demand of a user. In this manner, it is possible to provide an image suitable for the demand of a user.

An image processing device according to an eighth aspect includes the specific location information acquisition unit (the object information acquisition unit 152) that acquires information on a specific location; the position information processing unit that determines whether a position of a user is within a specific location based on position information of the user; the object detection unit 153 that detects an object (second object) associated with a specific location from image data; and the display mode change unit 154 that changes the display mode of the object (second object) when the position of the user is determined to be within the specific location. With this configuration, it is possible to detect a specific object that is present in a specific location from the image data, and to assign information for changing the display mode of the object to the image data, based on the demand of a user. In this manner, it is possible to provide an image suitable for the demand of a user.

An image processing method according to a ninth aspect includes: acquiring first object information; detecting from image data a first object and a second object associated with the first object; and changing a display mode of the second object when the first object is detected.

A computer program according to a tenth aspect causes a computer to execute: acquiring first object information; detecting from image data a first object and a second object associated with the first object; and changing a display mode of the second object when the first object is detected.

The computer program may be provided by being stored in a non-transitory computer-readable storage medium, or may be provided via a network such as the Internet. Examples of the computer-readable storage medium include optical discs such as a digital versatile disc (DVD) and a compact disc (CD), and other types of storage devices such as a hard disk and a semiconductor memory.

According to the embodiment, it is possible to provide an image processing device capable of providing an image suitable for the demand of the user, based on image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device comprising:
an object information acquisition unit configured to acquire information on a first object;
an object detection unit configured to detect from image data the first object and a second object associated with the first object; and
a display mode change unit configured to
change a display mode of the second object when the first object is detected and the second object is not a predetermined human face, and
not change the display mode of the second object when the first object is detected and the second object is a predetermined human face.

2. The image processing device according to claim 1, wherein
the object information acquisition unit is configured to acquire display mode change information that is a piece of data in which the first object, the second object, and a changed display mode of the second object are associated with one another, and
the display mode change unit is configured to change the display mode of the second object based on the display mode change information when the first object is detected.

3. The image processing device according to claim 1, wherein the display mode change unit is configured to change the display mode of the second object to a display mode in which character information is erased in the second object.

4. An image processing device comprising:
an object information acquisition unit configured to acquire information on a specific location and information on a first object;
a position information processing unit configured to determine whether a position of a user is within the specific location based on position information of the user;
an object detection unit configured to detect from image data the first object associated with the specific location and a second object associated with the first object; and
a display mode change unit configured to change a display mode of the second object when the position of the user is determined to be within the specific location and the first object associated with the specific location and the second object are detected.

5. An image processing method comprising:
acquiring information on a first object;
detecting from image data the first object and a second object associated with the first object; and
changing a display mode of the second object when the first object is detected and the second object is not a predetermined human face, and not changing the display mode of the second object when the first object is detected and the second object is a predetermined human face.
